(19) United States
(12) Patent Application Publication
(10) Pub. No.: US 2003/0030008 A1
(43) Pub. Date: Feb. 13, 2003

(54) Charged particle beam control system and charge partical beam optical apparatus using the system

(76) Inventors: Hirosi Sobukawa, Kanagawa (JP); Yoshikazu Sugiyama, Kanagawa (JP)

Correspondence Address: ARMSTRONG,WESTERMAN & HATTORI, LLP, 1725 K STREET, NW., SUITE 1000, WASHINGTON, DC, 20006, US

(21) Appl. No.: 10/191,804

(22) Filed: Jul. 10, 2002

(30) Foreign Application Priority Data
Jul. 11, 2001 (JP) 210863/2001

(51) Int. Cl. G21K 1/08

(52) U.S. Cl. 250/396 R

(57) ABSTRACT

A charged particle beam control system wherein electrodes and magnetic poles can be positioned accurately and easily is provided, together with a charged particle beam optical apparatus and a charged particle beam defect inspection apparatus, which use the charged particle beam control system. A part of a ceramic material is coated with a metal to form a pair of mutually opposing electrodes, and a pair of magnetic poles perpendicularly intersecting the pair of electrodes are provided to construct a Wien filter A. Side surfaces are formed on portions of the electrodes that are not coated with the metal, and first positioning surfaces are formed on the magnetic poles. The electrodes and the magnetic poles are positioned relative to each other by bringing the side surfaces and the positioning surfaces into abutting contact with each other, thereby allowing the electrodes and the magnetic poles to be positioned.

### BACKGROUND OF THE INVENTION

The present invention relates to a charged particle beam control system having electrodes for generating an electric field in the path of a charged particle beam and magnetic poles for generating a magnetic field in the path of the charged particle beam, and also relates to a charged particle beam optical apparatus and a charged particle beam defect inspection apparatus, which use the charged particle beam control system.

A Wien filter is generally known in which an electric field and a magnetic field perpendicularly intersecting each other are generated in the path of a beam of charged particles, e.g. electrons, whereby only charged particles having a predetermined velocity and energy are selectively allowed to travel straight. The Wien filter is widely used, for example, as an energy filter of a monochromator for energy analysis, or as a beam separator for a scanning electron microscope or a mapping electron microscope.

Conventionally, a Wien filter has a pair of mutually opposing electrodes and a pair of mutually opposing magnetic poles, which are combined together at right angles to each other. Positive and negative voltages are applied to the pair of mutually opposing electrodes, respectively, to generate an electric field between the electrodes that extends from one electrode to the other. In addition, south pole or north pole magnetism is applied to each of the pair of mutually opposing magnetic poles to generate a magnetic field between the magnetic poles that extends from one magnetic pole to the other. The Wien filter is arranged so that charged particles traveling with a predetermined velocity are allowed to travel straight through the Wien filter only when force applied to the charged particles from the electric field and force applied thereto from the magnetic field cancel each other.

Incidentally, when the electrodes and the magnetic poles, which constitute the Wien filter, are not accurately positioned and hence the distance between the pair of electrodes or the distance between the pair of magnetic poles is not uniform, or the positional relationship between the electrodes and the magnetic poles is not correct, the electric and magnetic fields generated in the area traversed by the charged particle beam become nonuniform, or the electric field and the magnetic field fail to intersect each other at right angles. In such a case, for example, a region where the force applied to the charged particles from the electric field and the force applied thereto from the magnetic field do not cancel each other occurs in the charged particle beam, unfavorably leading to the occurrence of aberrations.

Such a problem is not limited to the Wien filter but may be said to be common to all charged particle beam control systems having electrodes and magnetic poles because if the positions of the electrodes and the magnetic poles are not accurate, the distributions of electric and magnetic fields correspondingly change, undesirably.

Accordingly, it is common practice in a charged particle beam control system to mount the electrodes and the magnetic poles on the enclosure independently of each other. Among them, the electrodes, in particular, are attached to the enclosure in the state of being insulated from other portions by an insulating material or the like because voltages are applied to the electrodes. As a result, the number of parts for mounting the electrodes increases, and error factors associated with positioning increases. Thus, there has heretofore been a problem that it is difficult to accurately adjust the positions of the electrodes and the relative positions between the electrodes and the magnetic poles.

### SUMMARY OF THE INVENTION

The present invention has been made in view of the above-described circumstances. An object of the present invention is to provide a charged particle beam control system wherein electrodes and magnetic poles can be positioned accurately and easily.

Another object of the present invention is to provide a charged particle beam control system wherein each electrode is provided with a pair of positioning surfaces perpendicularly intersecting each other so that the pair of positioning surfaces allow a magnetic pole to be positioned with respect to the electrode accurately and easily in two directions perpendicularly intersecting each other.

A further object of the present invention is to provide a charged particle beam optical apparatus using such a charged particle beam control system.

A still further object of the present invention is to provide a charged particle beam defect inspection apparatus using such a charged particle beam control system.

To solve the above-described problem, a charged particle beam control system according to a first aspect of the present invention is a charged particle beam control system comprising an electrode for generating an electric field in a path along which charged particles pass, and a magnetic pole for generating a magnetic field in the path. The electrode is provided with a reference surface, and the magnetic pole has a positioning surface whose relative position with respect to the electrode is determined by abutment against the reference surface.

In the present invention, the reference surface provided on the electrode and the positioning surface provided on the magnetic pole abut against each other, whereby the electrode and the magnetic pole are positioned relative to each other accurately and easily. Because the electrode and the magnetic pole are placed in an accurate positional relationship, the relative positions of the electrodes and the relative positions of the magnetic poles are also accurately determined.

In this case, if the magnetic pole is electrically conductive and electrically connected with the electrode, the electrical potential of the magnetic pole becomes the same as that of the electrode. Consequently, the electric field that controls the charged particle beam is disordered unfavorably. Therefore, it is preferable that the magnetic pole should be formed from a substance having no electrical conductivity, e.g. ferrite, or the electrode and the magnetic pole should be electrically insulated from each other. To provide insulation between the electrode and the magnetic pole, for example, the reference surface provided on the electrode should be formed from a substance having insulating properties. More specifically, the reference surface should be coated with an insulating substance, or a portion of the electrode where a reference surface is to be formed should be formed from a substance having insulating properties.

A charged particle beam control system according to a second aspect of the present invention is as follows. In the charged particle beam control system according to the first aspect, the electrode is formed from a coating of an electrically conductive substance provided on a part of a surface of a non-magnetic material having insulating properties, exclusive of at least the reference surface.

The term “non-magnetic material” as used in this specification means a substance having a relative permeability value close to 1, including a paramagnetic material and a diamagnetic material, exclusive of ferromagnetic materials.

A charged particle beam control system according to a third aspect of the present invention is as follows. In the charged particle beam control system according to the second aspect, the non-magnetic material having insulating properties is formed from a ceramic material.

A charged particle beam control system according to a fourth aspect of the present invention is as follows. In the charged particle beam control systems according to the first to third aspects, a securing device for securing a magnetic pole by clamping it between the securing device and an electrode is provided.

A charged particle beam control system according to a fifth aspect of the present invention is as follows. In the charged particle beam control system according to the fourth aspect, the securing device is formed from a non-magnetic material.

A charged particle beam control system according to a sixth aspect of the present invention is a charged particle beam control system comprising an electrode for generating an electric field in a path along which charged particles pass, and a magnetic pole for generating a magnetic field in the path. The electrode comprises two electrodes disposed to face each other. Each electrode is provided with a reference surface. The magnetic pole comprises two magnetic poles disposed to face each other in a direction perpendicular to a direction in which the two electrodes are arranged. The magnetic poles have positioning surfaces, respectively, whose relative positions with respect to the electrodes are determined by abutment against the reference surfaces.

A charged particle beam control system according to a seventh aspect of the present invention is as follows. In the charged particle beam control system according to the sixth aspect, the reference surfaces each have a first reference surface for positioning the two mutually opposing magnetic poles in a direction in which the magnetic poles face each other, and a second reference surface for positioning the magnetic poles in a direction perpendicular to the direction in which the magnetic poles face each other.

A charged particle beam control system according to an eighth aspect of the present invention is as follows. In the charged particle beam control system according to the sixth aspect, the electrodes are each formed from a coating of an electrically conductive substance provided on a part of a surface of a non-magnetic material having insulating properties, exclusive of at least the reference surface.

The term “non-magnetic material” as used in this specification means a substance having a relative permeability value close to 1, including a paramagnetic material and a diamagnetic material, exclusive of ferromagnetic materials.

A charged particle beam control system according to a ninth aspect of the present invention is as follows. In the charged particle beam control system according to the eighth aspect, the non-magnetic material having insulating properties is formed from a ceramic material.

A charged particle beam control system according to a tenth aspect of the present invention is as follows. In the charged particle beam control system according to the sixth aspect, securing devices for securing the magnetic poles, respectively, by clamping them between the securing devices and the electrodes are provided.

A charged particle beam control system according to an eleventh aspect of the present invention is as follows. In the charged particle beam control system according to the tenth aspect, the securing devices are formed from a non-magnetic material.

A charged particle beam optical apparatus according to a first aspect of the present invention includes an optical system comprising at least one electron lens to lead a charged particle beam from a charged particle source through the electron lens. The optical system has at least one charged particle beam control system according to any of the first to fifth aspects of the present invention.

A charged particle beam optical apparatus according to a second aspect of the present invention includes an optical system comprising at least one electron lens to lead a charged particle beam from a charged particle source through the electron lens. The optical system has at least one charged particle beam control system according to any of the sixth to eleventh aspects of the present invention.

A charged particle beam defect inspection apparatus according to a first aspect of the present invention includes a primary optical system for leading a charged particle beam from a charged particle source to enter a path switching device as a primary beam and for applying the primary beam passing through the path switching device onto an object, and a secondary optical system for leading electrons, which are obtained from the object by application of the primary beam, to enter the path switching device as a secondary beam, so that the secondary beam is led through the path switching device in a direction different from a direction leading to the charged particle source and focused onto a detection surface. The path switching device is the charged particle beam control system according to the sixth or seventh aspect of the present invention.

### BRIEF DESCRIPTION OF THE DRAWINGS

FIG. 1 is a diagram showing the arrangement of an embodiment of a Wien filter as a charged particle beam control system according to the present invention.

FIG. 2 is a diagram showing the arrangement of an embodiment of a charged particle beam defect inspection apparatus according to the present invention that uses the charged particle beam control system shown in FIG. 1.

FIG. 3 is a diagram showing the path of a primary beam in the charged particle beam defect inspection apparatus according to the embodiment shown in FIG. 2.

FIG. 4 is a diagram for describing the operating principle of the Wien filter provided in the charged particle beam defect inspection apparatus according to the embodiment shown in FIG. 2.

FIG. 5 is a diagram showing the path of a secondary beam in the charged particle beam defect inspection apparatus according to the embodiment shown in FIG. 2.

### DESCRIPTION OF THE PREFERRED EMBODIMENTS

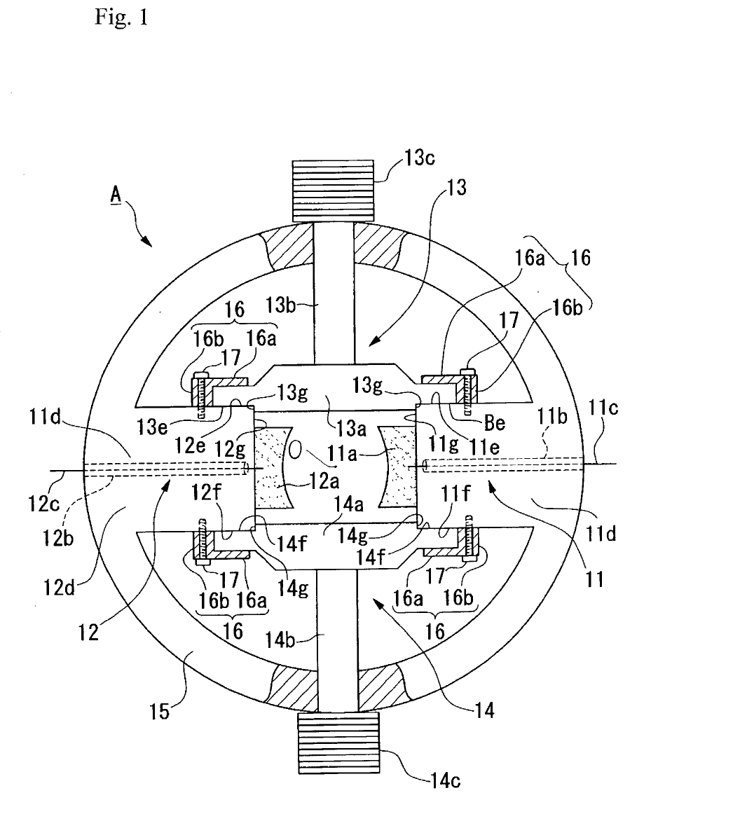

A charged particle beam control system according to an embodiment of the present invention, together with a charged particle beam optical apparatus and charged particle beam defect inspection apparatus using the same, will be described below in detail with reference to the drawings. FIG. 1 is a diagram showing the arrangement of a Wien filter as a charged particle beam control system according to an embodiment of the present invention. This Wien filter functions as a path switching device for a charged particle beam.

In the figure, a Wien filter A includes a pair of electrodes 11 and 12 disposed to face each other across a center axis 0 as a center and further includes a pair of magnetic poles 13 and 14 disposed to face each other across the center axis 0 as a center in a direction perpendicular to the direction in which the two electrodes 11 and 12 are arranged.

The electrodes 11 and 12 are formed from a ceramic material as a non-magnetic material having insulating properties and a relative permeability close to 1. The electrodes 11 and 12 are formed monolithically as a whole by cutting a single ceramic material so that proximal end portions 11d and 12d of the electrodes 11 and 12 provided at their respective proximal ends are contiguous with an annular outer ring portion 15. The surfaces of electrode projecting portions 11a and 12a projecting from the proximal end portions 11d and 12d toward the center axis 0 (i.e. the distal end surfaces closer to the center axis 0 and the side surfaces of the electrode projecting portions 11a and 12a) are coated with an electrically conductive material, such as Au and the like.

The Au coatings on the surfaces of the electrode projecting portions 11a and 12a are electrically connected with conductors 11c and 12c extending through respective conductor holes 11b and 12b provided in the ceramic material, so that a positive voltage and a negative voltage are applied to the Au coatings, respectively, from an electrode power source (not shown). The mutually opposing sides of the electrode projecting portions 11a and 12a are curved so as to be recessed with a predetermined curvature toward the respective proximal end sides so that an electric field generated between the electrodes 11 and 12 becomes uniform in the vicinity of the center axis 0.

The proximal end portions 11d and 12d are formed wider in width than the electrode projecting portions 11a and 12a. Side surfaces 11e and 11f of the proximal end portion 11d and side surfaces 12e and 12f of the proximal end portion 12d are formed parallel to each other along a direction in which the electrodes 11 and 12 face each other. The side surfaces 11e and 11f and the side surfaces 12e and 12f form first reference surfaces (reference surfaces) in this embodiment. The mutually opposing distal end surfaces 11g and 12g of the proximal end portions 11d and 12d are formed parallel to each other. The distal end surfaces 11g and 12g form second reference surfaces (reference surfaces) in this embodiment.

The magnetic poles 13 and 14 include pole plates 13a and 14a at their respective ends that face each other. The pole plates 13a and 14a are made of a ferromagnetic material, such as permalloy and the like. The magnetic poles 13 and 14 further have rod-shaped excitation portions 13b and 14b provided at the respective proximal ends, extending through the outer ring portion 15. The excitation portions 13b and 14b are made of a ferromagnetic material. In addition, the magnetic poles 13 and 14 have exciting coils 13c and 14c fitted around the excitation portions 13b and 14b, respectively. The excitation portions 13c and 14c are each supplied with an electric current from a magnetic pole power source (not shown).

The pole plate 13a has cut-off portions at both ends on the side thereof that faces the magnetic pole 14. A first positioning surface 13e (positioning surface) and a second positioning surface 13g (positioning surface), which intersect each other at right angles, are formed on each cut-off portion of the pole plate 13a. The pole plate 14a has cut-off portions at both ends on the side thereof that faces the magnetic pole 13. A first positioning surface 14f (positioning surface) and a second positioning surface 14g (positioning surface), which intersect each other at right angles, are formed on each cut-off portion of the pole plate 14a.

The pole plates 13a and 14a are disposed to extend over from the electrode 11 to the electrode 12. The first positioning surfaces 13e of the magnetic pole 13 abut against the respective side surfaces 11e and 12e, and the first positioning surfaces 14f of the magnetic pole 14 abut against the respective side surfaces 11f and 12f, whereby the magnetic poles 13 and 14 are positioned relative to the electrodes 11 and 12 in regard to the direction in which the magnetic poles 13 and 14 face each other. Thus, the tilt of the pole plates 13a and 14a and the distance therebetween are also determined.

Further, the second positioning surfaces 13g abut against the respective distal end surfaces 11g and 12g, and the second positioning surfaces 14g abut against the respective distal end surfaces 11g and 12g, whereby transverse displacement of the magnetic poles 13 and 14 and rotation thereof about the excitation portions 13b and 14b are restrained, and the magnetic poles 13 and 14 are positioned relative to the electrodes 11 and 12 in a plane perpendicularly intersecting the direction in which the magnetic poles 13 and 14 face each other.

The positioned pole plates 13a and 14a of the magnetic poles 13 and 14 are secured in such a manner as to be held between the electrodes 11 and 12 and clamps 16 (securing devices) secured to these electrodes. Thus, the clamps 16 press the pole plates 13a and 14a against the electrodes 11 and 12, whereby the side surfaces 11e and 12e and the first reference surfaces 13e are brought into close contact with each other, and the side surfaces 11f and 12f and the first reference surface 14f are brought into close contact with each other, thereby allowing the magnetic poles 13 and 14 to be accurately positioned with respect to the electrodes 11 and 12.

The clamps 16 are formed from a non-magnetic material and comprise, respectively, pressing portions 16a for pressing the pole plates 13a and 14a, and fixed portions 16b for supporting the pressing portions 16a. The fixed portions 16b are fixed to the electrodes 11 and 12 with screws 17 made of a non-magnetic material.

In addition, the Wien filter A includes a Wien filter control unit (not shown in FIG. 1) for controlling the electrode power source and the magnetic pole power source. The Wien filter control unit controls the electric field generated by the electrodes 11 and 12 and the magnetic field generated by the magnetic poles 13 and 14. Thus, the Wien filter A is arranged to generate an electric field and a magnetic field in the path of charged particles so that force applied to charged particles having a predetermined energy from the electric field and force applied thereto from the magnetic field are parallel and equal in magnitude to each other.

In the Wien filter A arranged as stated above, the electrodes 11 and 12 are formed from a ceramic material. Therefore, no short circuit is established even when the magnetic poles 13 and 14, which are formed from permalloy or the like, abut against the side surfaces 11e, 11f, 12e, 12f and the distal end surfaces 11g and 12g formed on the proximal end portions 11d and 12d, which are not coated with Au.

In addition, because the electrodes 11 and 12 can be mounted on an enclosure without using a member having insulating properties as an intermediary, the number of components of the electrodes 11 and 12 is reduced, and no error occurs in installation. In this embodiment, in particular, the electrodes 11 and 12 are formed by cutting a single ceramic material. Therefore, there is no need to align the electrodes 11 and 12 with each other.

Further, the end surface of the outer ring portion 15 (i.e. the end surface of the outer ring portion in a direction perpendicular to the plane of FIG. 1) is formed flat so that positioning can be effected. Accordingly, the whole Wien filter A can be positioned accurately.

Furthermore, ceramics are excellent in machinability and rigidity. Therefore, the configuration and positional accuracy of the electrodes 11 and 12 can be determined by the machining accuracy of the ceramic material, not by mechanical positional adjustment.

Accordingly, when the relative positions of the magnetic poles 13 and 14 with respect to the electrodes 11 and 12 are determined by abutment of the first positioning surfaces 13e of the magnetic pole 13 against the side surfaces 11e and 12e and by abutment of the first positioning surfaces 14f of the magnetic pole 14 against the side surfaces 11f and 12f, the positions of the magnetic poles 13 and 14 in the direction in which the magnetic poles 13 and 14 face each other are determined with a degree of accuracy equal to the machining accuracy of the side surfaces 11e and 11f and the side surfaces 12e and 12f. In addition, the second positioning surfaces 13g of the magnetic pole 13 abut against the distal end surfaces 11g and 12g, and the second positioning surfaces 14g of the magnetic pole 14 abut against the distal end surfaces 11g and 12g, whereby the position of each of the magnetic poles 13 and 14 in a plane perpendicularly intersecting the direction in which the magnetic poles 13 and 14 face each other is determined with a degree of accuracy equal to the machining accuracy of the distal end surfaces 11g and 12g.

Further, because the magnetic poles 13 and 14 are secured with the clamps 16, screw holes or the like are not provided in the magnetic poles 13 and 14. Therefore, the configurations of the magnetic poles 13 and 14 do not change in a complicated manner. Accordingly, the magnetic field generated by the magnetic poles 13 and 14 will not be disordered. Moreover, the clamps 16 and the screws 17, which are used to secure the magnetic poles 13 and 14, are also formed from a non-magnetic material. Therefore, there is no possibility of the magnetic field being disordered by the clamps 16 or the screws 17. Consequently, aberrations due to the disorder of the magnetic field will not be introduced into the charged particle beam.

In a case where holes or the like are formed in the magnetic poles 13 and 14 and thus the configurations thereof changes in a complicated manner, or in a case where a ferromagnetic material or the like is present near the magnetic poles 13 and 14, the influence thereof has to be analyzed by a numerical simulation. A markedly increased computation time is required to simply perform a calculation for each finely divided element of a magnetic pole with a complicated configuration by a finite element method or the like. This causes an increase in cost. Accordingly, it is possible to save labor and time for the numerical simulation and to reduce the cost by securing the magnetic poles 13 and 14 with the clamps 16 and the screws 17, which are formed from a non-magnetic material.

Further, securing the magnetic poles 13 and 14 with the clamps 16 does not require the use of an adhesive or the like. Therefore, there is no degradation of the vacuum due to a gas released from the adhesive. Furthermore, the problem of positional displacement will not occur, which would otherwise be caused by the adhesive interposed between the electrodes 11 and 12 and the magnetic poles 13 and 14.

Thus, the Wien filter A according to this embodiment allows the electrodes 11 and 12 and the magnetic poles 13 and 14 to be assembled accurately and easily. The positioning of the magnetic poles 13 and 14 with respect to the electrodes 11 and 12 can readily be effected by bringing the first positioning surfaces 13e and 14f and the second positioning surfaces 13g and 14g of the magnetic poles 13 and 14 into abutting contact with the side surfaces 11e, 11f, 12e, 12f and the distal end surfaces 11g and 12g of the electrodes 11 and 12, respectively.

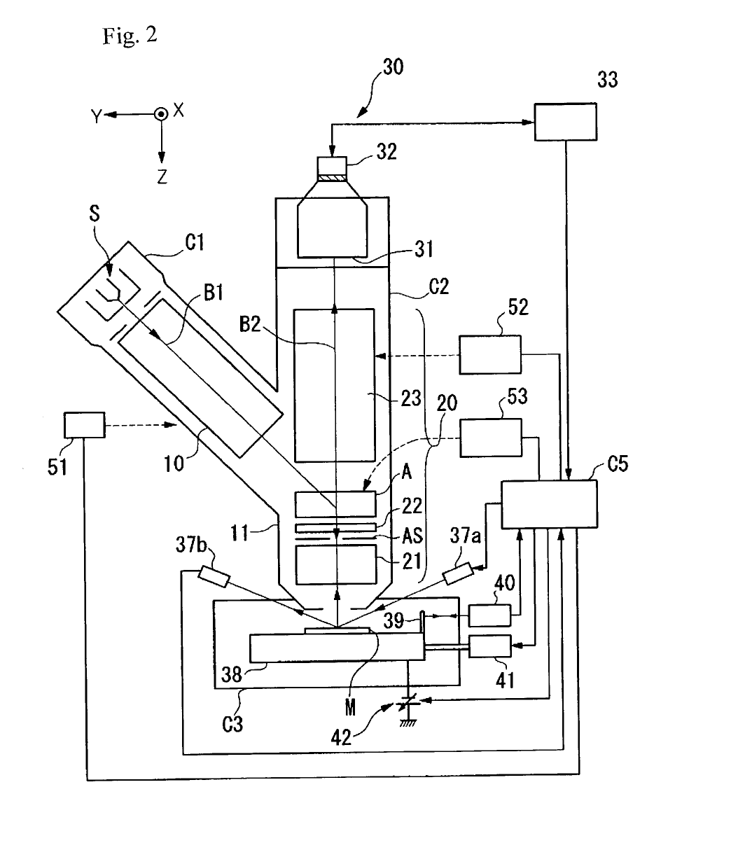

FIG. 2 is a diagram showing the arrangement of a charged particle beam defect inspection apparatus according to an embodiment of the present invention that has a Wien filter A such as that shown in FIG. 1. In the following description, an XYZ orthogonal coordinate system is set as shown in FIG. 2, and the positional relationship between constituent members will be described with reference to the XYZ coordinate system. In the XYZ orthogonal coordinate system shown in FIG. 2, an XY plane is set in the object plane of a sample, and the direction normal to the object plane of the sample is set in the Z axis direction. The XYZ coordinate system shown in FIG. 2 is actually such that the XY plane is set in a plane parallel to the horizontal plane, and the Z axis is set in the vertically downward direction.

The charged particle beam defect inspection apparatus according to this embodiment mainly comprises a primary column C1 for leading an electron beam (charged particle beam) to a sample M (object) as a primary beam B1, a secondary column C2 for focusing secondary electrons, which are obtained from the sample M when the electron beam is applied thereto, onto a detection surface 31 of a detector 30 as a secondary beam B2, and a chamber C3 for accommodating the sample M as an object of observation. The optical axis of the primary column C1 is set in a direction oblique to the Z axis. The optical axis of the secondary column C2 is set approximately parallel to the Z axis. Accordingly, the primary beam B1 from the primary column C1 enters the secondary column C2 obliquely. The primary column C1, the secondary column C2 and the chamber C3 are connected with a vacuum evacuation system (not shown) so as to be evacuated by a vacuum pump, such as a turbopump and the like, provided in the vacuum evacuation system. Thus, the insides of the primary column C1, the secondary column C2 and the chamber C3 are maintained in a vacuum state.

The primary column C1 is provided therein with a thermoelectron emission type electron gun S as a charged particle source. A primary optical system 10 is disposed on the optical axis of an electron beam emitted from the electron gun S. The primary optical system 10 comprises a field stop, irradiation lenses, an aligner, an aperture, etc. The irradiation lenses are electron lenses, e.g. circular lenses, quadrupole lenses, or octopole lenses. The converging characteristics of these lenses with respect to the primary beam B1 change according to the value of the voltage applied thereto. It should be noted that the irradiation lenses may be rotationally symmetric lenses known as “unipotential lenses” or “Einzel lenses”.

A secondary optical system 20 is placed in the secondary column C2. The secondary optical system 20 leads secondary electrons emitted from the sample M when irradiated with the primary beam B1 as a secondary beam B2 and focuses it onto the detection surface 31 of the detector 30. The secondary optical system 20 includes, in order from the sample M side in the −Z direction, a first pre-lens 21, an aperture stop AS, a second pre-lens 22, a Wien filter A, and a post-optical system 23 having a stigmator, image-forming lenses, an aligner, a field stop, etc. The first pre-lens 21, the second pre-lens 22 and the image-forming lenses in the secondary optical system 20 are electron lenses, such as circular lenses, quadrupole lenses, or octopole lenses and the like. It should be noted that the first pre-lens 21, the second pre-lens 22 and the image-forming lenses may be rotationally symmetric lenses known as “unipotential lenses” or “Einzel lenses”.

A main control system C5 controls the values of voltage and electric current supplied to each part of the primary and secondary optical systems 10 and 20. More specifically, the main control system C5 outputs control signals to a primary optical system control unit 51, a secondary optical system control unit 52 and a Wien filter control unit 53 to control the optical characteristics of the primary and secondary optical systems 10 and 20 and to perform electric and magnetic field control for the Wien filter A.

As has been stated above, the charged particle beam defect inspection apparatus is arranged as a charged particle beam optical apparatus having an optical system for leading a charged particle beam from a charged particle source

The detector 30 which detects the secondary beam B2 imaged on the detection surface 31 through the secondary optical system 20 is structured such that the detected electrons are amplified and then converted into a light signal through a fluorescent screen, and the light signal enters a camera 32 equipped with a TDI sensor, for example. The camera 32 is connected with a control unit 33 that is controlled by the main control system C5 to read image signals from the camera 32 and to sequentially output them to the main control system C5. The main control system C5 performs image processing, such as template matching and the like, on the image signals output from the control unit 33 to judge whether or not there is a defect on the sample M.

Further, an XY stage 38 is provided in the chamber C3. The XY stage 38 is movable in the XY plane with the sample M placed thereon. An L-shaped moving mirror 39 is secured to one end of the XY stage 38. A laser interferometer 40 is disposed at a position facing the mirror surface of the moving mirror 39. The laser interferometer 40 measures the X and Y coordinates of the XY stage 38 and the angle of rotation thereof in the XY plane by using the reflected laser beam from the moving mirror 39. The results of the measurement are output to the main control system C5. The main control system C5 outputs a control signal to a driver 41 on the basis of the measurement results to control the position of the XY stage 38 in the XY plane. The main control system C5 further outputs a control signal to a Z sensor comprising a light-sending system 37a and a light-receiving system 37b to measure the coordinate of the position of the sample M in the Z axis direction. It is preferable to provide, in addition to the XY stage 38, a Z stage (not shown) for changing the position of the sample M in the Z axis direction on the basis of the measurement of the position coordinate in the Z axis direction and a tilt stage (not shown) for controlling the tilt of the object plane of the sample M with respect to the XY plane.

Reference numeral 42 in the figure denotes a variable power source for setting a negative voltage for the sample M. The set voltage of the sample M is controlled by the main control system C5. The reason why a negative voltage is set for the sample M is to accelerate secondary electrons emitted from the sample M when irradiated with the primary beam B1 as a secondary beam B2 in the direction of the first pre-lens 21, i.e. in the −Z direction.

The charged particle beam defect inspection apparatus having the beam deflector A according to this embodiment is arranged as stated above. Next, let us detail the method for defect inspection of the sample M carried out by the charged particle beam defect inspection apparatus while describing the paths of the primary and secondary beams B1 and B2 and the switching between the paths of the primary and secondary beams B1 and B2 by the Wien filter A.

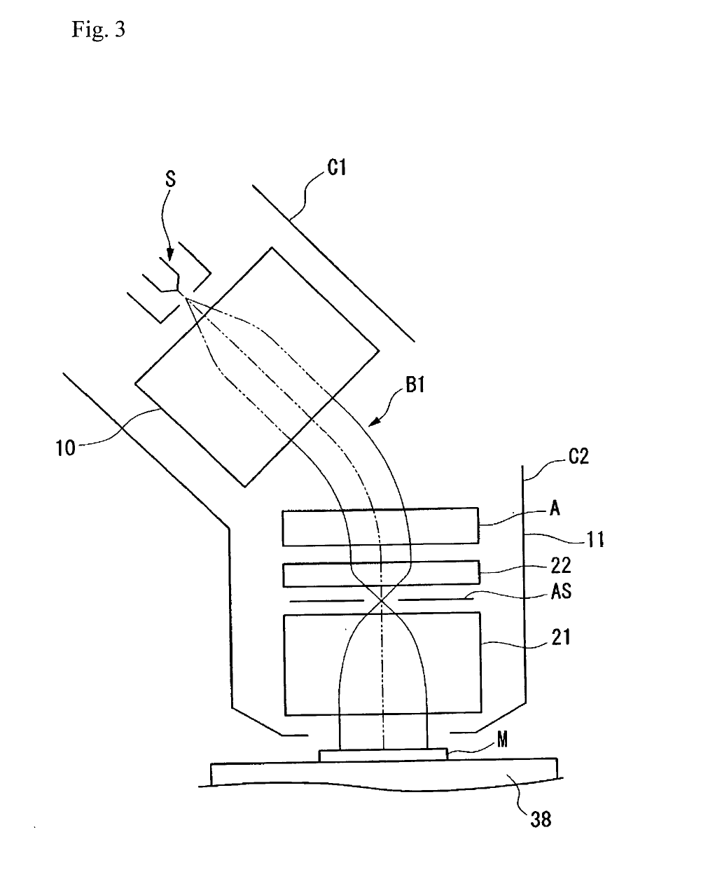

FIG. 3 is a diagram showing the path of the primary beam B1 in the charged particle beam defect inspection apparatus according to the embodiment of the present invention. In the figure, illustration of the members provided in the primary optical system 10 is omitted with a view to facilitating understanding. The primary beam B1 emitted from the electron gun S is converged or diverged (illustration of the envelope of the beam in the primary optical system 10 is omitted) under the influence of electric fields formed by the irradiation lenses in the primary optical system 10. Thus, the primary beam B1 is formed into a parallel beam and enters the Wien filter A from an oblique direction. As the primary beam B1 passes through the Wien filter A, the optical path thereof is deflected to a direction approximately parallel to the Z axis. The primary beam B1 deflected by the Wien filter A is focused by the second pre-lens 22 to reach the aperture stop AS where it forms an image of the electron gun 10. The primary beam B1 passing through the aperture stop AS is subjected to the lens action of the first pre-lens 21 to illuminate the sample M with Koehler illumination.

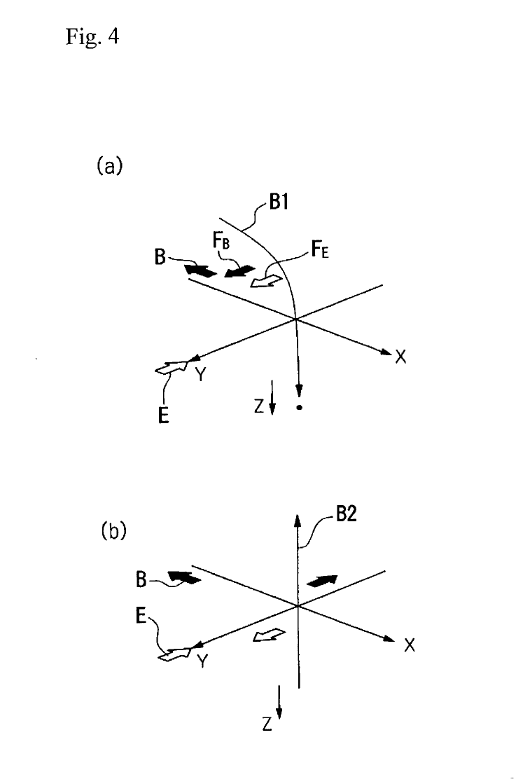

The Wien filter A is a charged particle beam control system as a beam separator (path switching device) that deflects charged particles or allows them to travel straight according to the travel direction of the charged particles. FIG. 4 is a diagram for describing the operating principle of the Wien filter A. As shown in the figure, the primary beam B1 entering the Wien filter A from the primary optical system 10 is deflected by the Wien filter A. The reason for this is as follows. As shown in FIG. 4(a), when electrons with an electric charge q that form the primary beam B1 travel at a velocity v in the +Z axis direction through a field where an electric field E and a magnetic field B perpendicularly intersect each other, the electrons are subjected to the resultant force from force F_{E} (=qE) due to the electric field and force F_{B} (=qvB) due to the magnetic field, which act in the +Y direction in parallel to each other. On the other hand, the secondary beam B2 emitted from the sample M travels straight through the Wien filter A. The reason for this is as follows. As shown in FIG. 4(b), when electrons with an electric charge q that form the secondary beam B2 travel at a velocity v in the −Z axis direction, the electrons are subjected to the resultant force from force F_{E} (=qE) due to the electric field that acts in the +Y direction and force F_{B} (=−qvB) due to the magnetic field that acts in the −Y direction in parallel to the force F_{E}. In this embodiment, an electric field and a magnetic field that intersect each other at right angles are generated so that the condition of E=vB is satisfied for electrons with a predetermined energy that travels at a velocity v. Therefore, regarding forces F_{E} and F_{B} parallel and equal in magnitude to each other, the resultant force F_{E}+F_{B} becomes zero. Thus, the Wien filter A has the function of operating as an electromagnetic prism for selecting an optical path for an electron beam passing therethrough.

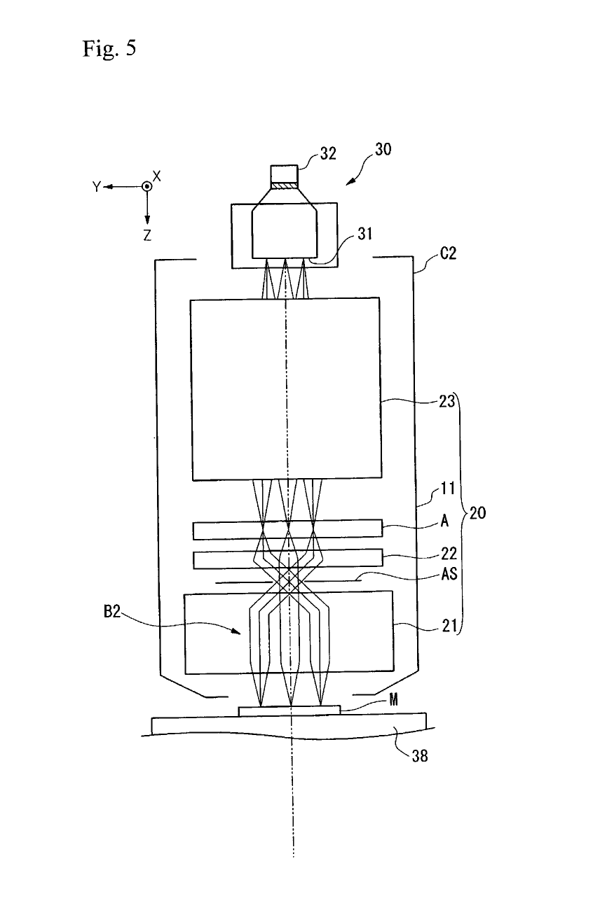

The process wherein secondary electrons obtained from the sample M when irradiated with the primary beam B1 are focused onto the detection surface of the detector 30 as the secondary beam B2 will be described below. First, when the sample M is irradiated with the primary beam B1, secondary electrons are obtained from the sample M. The secondary electrons are distributed according to the surface configuration of the sample M, the material distribution thereof, the variation in the electric potential, and so forth. The secondary electrons are used as the secondary beam B2 to inspect the surface condition of the sample M. FIG. 5 is a diagram showing the path of the secondary beam B2 in the charged particle beam defect inspection apparatus according to the embodiment of the present invention. In the figure, illustration of some members provided in the secondary optical system 20 is omitted with a view to facilitating understanding. The energy of secondary electrons emitted from the sample M is low, i.e. of the order of 0.5 to 2 eV. The secondary electrons are focused as the secondary beam B2 while being accelerated through the first pre-lens 21. Subsequently, the secondary beam B2 passes through the aperture stop AS. The secondary beam B2 passing through the aperture stop AS is focused by the second pre-lens 22 so that an intermediate image formation plane is set in the center of the Wien filter A. The secondary beam B2 entering the Wien filter A from a direction opposite to the direction of incidence of the primary beam B1 is led by the Wien filter A in a direction different from the direction leading to the electron gun S. Thus, the secondary beam B2 is allowed to travel straight and imaged on the detection surface 31 of the detector 30 as an enlarged image of the object plane of the sample M by the post-optical system 23.

In the charged particle beam defect inspection apparatus arranged as stated above, the electrodes 11 and 12 and the magnetic poles 13 and 14 are accurately positioned. Consequently, the occurrence of aberrations due to the disorder of the electric and magnetic fields in the path of the charged particle beam is suppressed. Further, the charged particle beam defect inspection apparatus is arranged so that an intermediate image formation plane is set in the Wien filter A. Therefore, the overall resolution of the apparatus can be improved.

Although in the foregoing embodiment a pair of electrodes and a pair of magnetic poles are disposed, it should be noted that the number of pairs of electrodes and the number of pairs of magnetic poles may be two or more. If a plurality of pairs of electrodes and magnetic poles are provided, it is possible to apply multipole components to the electric and magnetic fields and hence possible to reduce aberrations. In this case also, the electrodes and the magnetic poles can be positioned accurately by bringing the reference surfaces provided on the electrodes and the positioning surfaces provided on the magnetic poles into abutting contact with each other.

Although in the foregoing embodiment the electrodes are formed from a ceramic material and the magnetic poles are formed from a metal, such as permalloy and the like, the arrangement may be such that the electrodes are formed from a metal and the magnetic poles are formed from a ferromagnetic material having insulating properties, such as ferrite and the like. Such an arrangement also allows the electrodes and the magnetic poles to be accurately positioned, provided that reference surfaces are provided on the electrodes and positioning surfaces are provided on the magnetic poles. Because the magnetic poles have insulating properties, no short circuit is established between the electrodes even if the electrodes and the magnetic poles come in contact with each other.

Furthermore, the arrangement may be such that electrodes are formed from a metal, and insulators are disposed only on respective portions of the electrodes where reference surfaces are to be provided, and then reference surfaces are formed on the insulators. The insulators are positioned on the body portions of the electrodes. Positioning of the magnetic poles are effected by abutment of the magnetic poles against the reference surfaces of the insulators positioned on the body portions of the electrodes. The insulation between the electrodes and the magnetic poles can be maintained by the above-described arrangement, in which an insulator is sandwiched between a magnetic pole and the body portion of an electrode made of a metal. Such an arrangement allows electrodes to be formed from an easily workable metal.

According to the charged particle beam control system of the present invention, electrodes are provided with reference surfaces, and positioning surfaces provided on magnetic poles are brought into abutting contact with the reference surfaces, whereby the relative positions of the magnetic poles with respect to the electrodes are determined. Accordingly, the electrodes and the magnetic poles can be positioned accurately and easily.

Although the present invention has been described above in detail with reference to the drawings, the foregoing description is for explanatory purposes and not intended to limit characteristics. It should be understood that the foregoing description merely illustrates and explains preferred embodiments, and all modifications and changes within the scope of the spirit of the present invention are protected.

The entire disclosure of Japanese Patent Application No. 2001-210863 filed on Jul. 11, 2001 including specification, claims, drawings and summary is incorporated herein by reference in its entirety.

What is claimed is:

1. A charged particle beam control system comprising an electrode for generating an electric field in a path along which charged particles pass and a magnetic pole for generating a magnetic field in said path, said system characterized in that
said electrode is provided with a reference surface; and
that said magnetic pole has a positioning surface whose relative position with respect to said electrode is determined by abutment against said reference surface.

2. A charged particle beam control system according to claim 1, wherein said electrode is formed from a coating of an electrically conductive substance provided on a part of a surface of a non-magnetic material having insulating properties, exclusive of at least said reference surface.

3. A charged particle beam control system according to claim 2, wherein said non-magnetic material having insulating properties is formed from a ceramic material.

4. A charged particle beam control system according to claim 1, which has a securing device for securing said magnetic pole by clamping it between said securing device and said electrode.

5. A charged particle beam control system according to claim 4, wherein said securing device is formed from a non-magnetic material.

6. A charged particle beam control system comprising an electrode for generating an electric field in a path along which charged particles pass and a magnetic pole for generating a magnetic field in said path, said system characterized in that
said electrode comprises two electrodes disposed to face each other, each electrode being provided with a reference surface;
that said magnetic pole comprises two magnetic poles disposed to face each other in a direction perpendicular to a direction in which said two electrodes are arranged, and
that said magnetic poles have positioning surfaces, respectively, whose relative positions with respect to said electrodes are determined by abutment against said reference surfaces.

7. A charged particle beam control system according to claim 6, wherein said reference surfaces each have a first reference surface for positioning said two mutually opposing magnetic poles in a direction in which said magnetic poles are arranged, and a second reference surface for positioning said magnetic poles in a direction perpendicular to said direction in which said magnetic poles are arranged.

8. A charged particle beam control system according to claim 6, wherein said electrodes are each formed by a coating an electrically conductive substance on a part of a surface of a non-magnetic material having insulating properties, exclusive of at least said reference surface.

9. A charged particle beam control system according to claim 8, wherein said non-magnetic material having insulating properties is formed from a ceramic material.

10. A charged particle beam control system according to claim 6, which has securing devices for securing said magnetic poles, respectively, by clamping them between said securing devices and said electrodes.

11. A charged particle beam control system according to claim 10, wherein said securing devices are formed from a non-magnetic material.

12. A charged particle beam optical apparatus comprising:
an optical system having at least one electron lens to lead a charged particle beam from a charged particle source through said electron lens;
wherein said optical system has the charged particle beam control system according to claim 1.

13. A charged particle beam optical apparatus comprising:
an optical system having at least one electron lens to lead a charged particle beam from a charged particle source through said electron lens;
wherein said optical system has the charged particle beam control system according to claim 6.

14. A charged particle beam optical apparatus comprising:
an optical system having at least one electron lens to lead a charged particle beam from a charged particle source through said electron lens;
wherein said optical system has the charged particle beam control system according to claim 7.

15. A charged particle beam defect inspection apparatus comprising:
a primary optical system for leading a charged particle beam from a charged particle source to enter a path switching device as a primary beam and for applying said primary beam passing through said path switching device onto an object; and
a secondary optical system for leading electrons, which are obtained from said object by application of said primary beam, to enter said path switching device as a secondary beam, so that said secondary beam is led through said path switching device in a direction different from a direction leading to said charged particle source and focused onto a detection surface;
wherein said path switching device is the charged particle beam control system according to claim 6.

16. A charged particle beam defect inspection apparatus comprising:
a primary optical system for leading a charged particle beam from a charged particle source to enter a path switching device as a primary beam and for applying said primary beam passing through said path switching device onto an object; and
a secondary optical system for leading electrons, which are obtained from said object by application of said primary beam, to enter said path switching device as a secondary beam, so that said secondary beam is led through said path switching device in a direction different from a direction leading to said charged particle source and focused onto a detection surface;
wherein said path switching device is the charged particle beam control system according to claim 7.
